(19) United States
(12) Patent Application Publication
(10) Pub. No.: US 2005/0222446 A1
(43) Pub. Date: Oct. 6, 2005

(54) Process for the production of hydrocarbyl silyl carboxylate compounds

(76) Inventor: Mark Plehiers, Bruxelles (BE)

Correspondence Address: GOODWIN PROCTER L.L.P, 103 EISENHOWER PARKWAY, ROSELAND, NJ, 07068, US

(21) Appl. No.: 10/508,219

(22) PCT Filed: Dec. 8, 2003
(86) PCT No.: PCT/EP03/13889

§ 371 Date: Apr. 4, 2005

(30) Foreign Application Priority Data
Dec. 20, 2002 (EP) 02258931.1

(51) Int. Cl. C07F 7/04; C07F 7/08

(52) U.S. Cl. 556/442

(57) ABSTRACT

A process for the production of hydrocarbyl silyl carboxylatcs of formula (I)is described. Wherein n represents a number of dihydrocarbylsiloxane units ftom 0 to 1000, by reaction of a carboxylic acid of formula (II) with a hydrocarbyl silyl compound of formula (III) the reaction being carried out in the presence of a silaphilic catalyst.

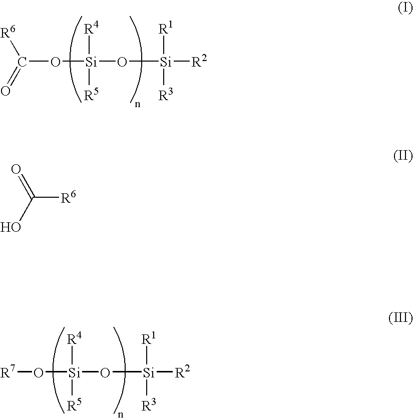

Hydrocarbyl silyl (poly) carboxylatas are valuable intermediates in organic synthesis. Indeed, they are considered as highly reactive coupling and silylating agents. Accordingly, the economic production of the silyl carboxylate monomer will make an important contribution to commercial systems.

Several processes are known for the synthesis of acyloxysilanes.

T. W. Greene and P. G. M. Wuts disclose in “Protective groups in organic synthesis” (J. Wiley & Sons, Inc., New York, 3rd. ed., 1999) the synthesis of acyloxysilane from carboxylic acid and silicon halide in the presence of a base.

The reaction of silyl hydrides with carboxylic acids in the presence of various metal catalysts to provide acyloxysilanes is disclosed in Zh. Obshch. Khim. 24, 861, 1954, Bull. Chem. Soc. Jap. 62(2), 211, 1989 and in Org. Letters 2(8), 1027, 2000. These methods have the disadvantage of releasing hydrogen as by product.

U.S. Pat. No. 4,379,766 discloses the reaction of a carboxylic acid salt with a silicon halide in the presence of phase transfer catalysts to produce acyloxysilane. This reaction has the disadvantage to yield as by-product a halide salt, which has to be removed by filtration.

J. Valade describes in “C. R. Acad. Sci.” n° 246, pp.952-953 (1958) that silyl esters were obtained by the reaction at reflux of disiloxanes with acetic anhydride or benzoic anhydride in the presence of zinc chloride.

Reaction mechanisms of nucleophilic attack at silicon have been disclosed in the literature. Bassindale et al, The Chemistry of Organic Silicon Compounds, chapter 13, J Wiley & Sons 1989, discloses extensive reaction mechanisms for silicon. However, the nucleophilic reaction mechanisms relate to halo substituted silicon type compounds and these are encouraged by the halogen leaving group.

EP 056108A1 (Dow Corning Corporation) discloses the acid catalysed reaction of alkoxysilanes with carboxylic acids to produce alkyl carboxylates and disiloxanes.

Nakao et al, Bulletin of the Chemical Society Japan, 54, 1267-1268 (1981) discloses the esterification of carboxylic acids with alcohols in the presence of trimethyl chlorosilane. The reaction is said to proceed via the intermediate alkoxy trimethyl silane and produces the alkyl ester in high yield together with disiloxane. The yields of methyl acetate are 96-98%.

Roth et al (Journal of Organometallic Chemistry 521 (1996) 65-74) disclose a study of the reactions of tartaric acid with triethoxysilane to study the extent of liberation of hydrogen gas. For spectroscopic comparative purposes, acetoxytriethoxysilane was prepared. The production of acetoxy triethoxy silane is carried out by the reaction of acetic anhydride with tetra-ethoxysilane at high temperature for ten hours. The product produced only 9% yield. It has also been shown (Lesnov et al. Zh. Obshch. Khim, 29, 1959, 1518) that diethyl diethoxy silanes will polymerise with monocarboxylic acids to produce polydiethyl siloxanes and the ethyl esters of the acid. The authors suggest that, diethyl diacetoxysilane was formed as an intermediate in the production of the polydiethylsiloxanes. The intermediate was formed in low yield. Furthermore, the document indicates that the production of intermediate diacetoxysilane in the presence of the alcohol leads to the formation of the corresponding alkyl esters.

JP 50020053 discloses silylation reaction of chloro and acyloxy silanes with hydroxyl containing organic compounds in the presence of formamide.

R Corriu, R Perez and C Reye Tetrahedron 39, 6 999 (1982) disclose the catalytic effect of fluoride anions in reactions at silicon of various silyl hydrides, ethers and amines.

It is one of the objects of the present invention to provide a more convenient and efficient process for the production of hydrocarbyl silyl carboxylate compounds.

According to a first aspect of the present invention there is provided a process for the production of hydrocarbyl silyl carboxylates of formula (I) 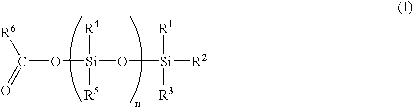
wherein each R′ and R⁵ may be hydroxyl or may be independently selected from alkyl, aryl, alkoxyl, aryloxyl, —O—SiR¹R²R³, —O—(SiR⁴R⁵O)ₙ-SiR¹R²R³, alkenyl, alkynyl, aralkyl or aralkyloxyl radicals optionally substituted by one or more substituents independently selected from the group comprising alkyl, alkoxyl, aralkyl, aralkyloxyl, hydroxyl aryl, aryloxyl, silyl, —O—SiR¹R²R³, —O—(SiR⁴R⁵O)ₙ-SiR¹R²R³, halogen, amino (preferably, tertiary amino) or amino alkyl radicals or R⁴ or R⁵ may be an —O—C(O)R⁶ group,
wherein R¹, R² and R³ each independently represent hydrogen, hydroxyl, alkyl, alkenyl, alkynyl, alkoxyl, —O613 SiR³R²R³, —O—(SiR⁴R⁵O)_{N}-SiR¹R²R³, aryl, aryloxyl, aralkyl or aralkyloxyl radical optionally substituted by one or more substituents independently selected from the group comprising alkyl, alkoxyl, aralkyl, aralkyoxyl, aryl, aryloxyl, silyl, —O—SiR¹R²R³₁, —O—(SiR⁴R⁵)ₙ-SiR¹R²R³, halogen, hydroxyl, amino (preferably tertiary amino) or amino alkyl radicals or R¹, R² and R³ may independently be an —O—C(O)R⁶ group,
wherein R⁶ is a hydrogen atom, or independently represents alkyl, alkenyl, alkynyl, aryl, aralkyl radical optionally substituted by one or more substituents independently selected from the group comprising alkyl, alkenyl, alkynyl, aralkyl, aryl, halogen, hydroxyl, amino or amino alkyl radicals or may be -(R⁸)_{P}COOR⁹ wherein P may be 0 or 1 and when P=1, R⁸ is selected from alkyl, alkenyl, alkynyl aryl, aralkyl radical optionally substituted by one or more substituents independently selected from alkyl, alkenyl, alkynyl, aralkyl, aryl, hydroxyl, halogen, amino or amino alkyl radicals, wherein R⁹ is a hydrogen atom or may be independently selected from alkyl, alkenyl, alkynyl, aryl, aralkyl, -SiR¹R²R³ or -(SiR⁴R⁵O)ₙ-SiR¹R²R³ radical optionally substituted by one or more substituents independently selected from the group comprising alkyl, alkenyl, alkynyl, aryl, aryloxyl, aralkyl, aralkyloxyl, halogen, hydroxyl, alkoxyl, amino or aminoalkyl radicals and wherein R¹, R², R³, R⁴ and R⁵ are as already defined;
and wherein
each n independently represents a number of dihydrocarbylsiloxane units from 0 to 1000;
by reaction of a carboxylic acid of formula (II) 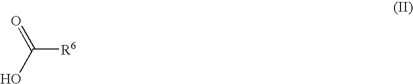
   wherein R⁶ is as defined above; with a hydrocarbyl silyl compound of formula (III) 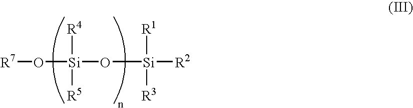
   wherein R¹, R², R³, R⁴, R⁵ and n are as defined above and R⁷ is an hydrogen atom, an aralkyl, aryl, alkenyl, alkynyl, alkyl group optionally substituted with one or more substituents selected from the equivalent substituents as defined for R¹-R⁵ above; the said reaction being carried out in the presence of a silaphilic catalyst.

For the avoidance of doubt, where a group is defined above, such as R¹, the group in formula (III) may not necessarily be identical in formula (I). For instance, if R¹ is alkoxyl in formula III, it may be O—C(O)R ⁶ in formula I. Generally, if any of the groups defined above in relation to formulas (I) and (III) are potential leaving groups, they may be substituted in formula (I) and represent a different group in the possible selection of groups.

Preferably, wherein when R¹, R², R³, R⁴ and R⁵ are alkoxyl, aryloxyl, alkaryloxyl or hydroxyl in formula III, they may independently represent —O—C(O)R⁶ in formula I.

Preferably, wherein when R⁹ represents an alkyl, alkenyl, alkynyl aryl, aralkyl radical or hydrogen atom in formula (II), it may represent -(SiR⁴R⁵—O)ₙSiR¹R²R³ in formula (I).

Preferably, the silaphilic catalysts are selected from fluoride containing mineral or organic salts which comprise, but are not limited to, sodium fluoride, potassium fluoride, caesium fluoride or tetrabutyl ammonium fluoride (Bu₄NF); or are selected from N-methyl imidazole (NMI), N,N-dimethylamino pyridine (DMAP), hexamethylphosphoric triamide (HMPA), 4,4 dimethyl imidazole, N-methyl-2-pyridone (NMP), pyridine N-oxide, triphenylphosphine oxide, 2,4 dimethyl pyridine, N-methyl-4pyridone, dimethyl formamide(DMF), 3,5 dimethyl pyridine, N,N-dimethylethylene Urea (DMEU), N,N-dimethylpropylene Urea(DMPU), pyridine, imidazole, trimethylamine, dimethyl sulphoxide (DMSO), N-methyl pyrrolidinone (NMP), formamide, N-alkylformamides, N,N-dialkylformamides, acetamide, N-alkylacetamides, N,N-dialkylacetamides, alkylcyanides, N-methyl pyrrolidone, p-dimethylaminobenzaldehyde, 1,2-dimethyl imidazole, LiOH, LiStearate, NaI, MeONa or MeOLi; the term alkyl in the above N-alkyl and N,N-dialkyl . . . amides and cyanides includes any linear, cyclic, bicyclic, polycyclic, alkyl aliphatic or aromatic group and in the case of N,N-compounds the alkyl may be the same or different, an example is N-formyl Rosinamine.

Silaphilic catalysts have been defined as molecules having a special affinity for silicon—Brook, Silicon in Organic, Organometallic and Polymer Chemistry section 5.5, J Wiley & Sons 2000. Preferably, the silaphilic catalysts have an electron rich heteroatom such as oxygen or nitrogen. Typically, the hetero atom is substituted with electron donating groups.

Lewis acid catalysts may also be used to catalyse the process of the present invention. Accordingly, for the purposes of the present invention, the term “silaphilic catalyst” should be taken as incorporating Lewis acid catalysts such as titanium butoxide (TiOBu)₄).

Said catalyst may, for example, be a metal alkoxide, an organic tin compound such as dibutyltin dilaurate, dibutyltin dioctiate or dibutyltin diacetate, or a boron compound such as boron butoxide or boric acid. Illustrative examples of metal alkoxide include aluminum triethoxide, aluminum triisopropoxide, aluminum tributoxide, aluminum tri-sec-butoxide, aluminum diisopropoxy-sec-butoxide, aluminum diisopropoxyacetyl acetonate, aluminum di-sec-butoxyacetyl acetanoate, aluminum diisopropoxyethyl acetoacetate, aluminum di-sec-butoxyethylacetoacetate, aluminum trisacetyl acetonate, aluminum trisethylaceto acetate, aluminum acetylacetonate bisethylacetoacetate, titanium tetraethoxide, titanium tetraisopropoxide, titanium (IV) butoxide, titanium diisopropoxybisacetyl acetonate, titanium diisopropoxybisethyl acetoacetate, titanium tetra-2-ethylhexyloxide, titanium diisopropoxybis (2-ethyl-1,3-hexanediolate), titanium dibutoxybis (triethanolaminate), zirconium tetrabutoxide, zirconium tetraisopropoxide, zirconium tetramethoxide, zirconium tributoxide monoacetylacetonate, zirconium dibutoxide bisacetylacetonate, zirconium butoxide trisacetylacetonate, zirconium tetraacetylacetonate, zirconium tributoxide monoethylacetoacetate, zirconium dibutoxide bisethylacetoacetate, zirconium butoxide trisethylacetoacetate and zirconium tetraethylacetoacetate. In addition to these compounds, cyclic 1,3,5-triisopropoxycyclotrialuminoxane and the like can also be used and is thereby incorporated within the definition of “silaphilic catalyst”.

Advantageously, although the prior art describes the reaction of alkoxysilanes with carboxylic acid as leading to the corresponding alkylcarboxylates and the silanol (path A), the latter tending to dehydrate to form disiloxanes. It has been surprisingly discovered that the use of a silaphilic catalyst (i.e. a catalyst able to coordinate in a reversible manner with the silicon atom) allows preferential substitution of alkoxy or hydroxyl groups by the carboxyl group (path B).

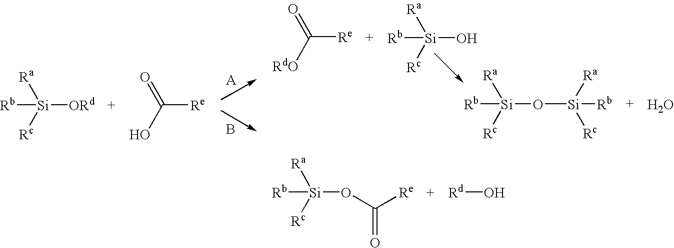

Preferably, in compounds of formula I, the number of acyloxy groups may be more than 1, preferably 1-100, more preferably, 1-50, most preferably, 1-10. For the avoidance of doubt, formula I may represent a polymer when R⁴ or R⁵ are di- or poly-carboxylic acid derivatives.

More preferably, the silaphilic catalyst is a catalyst capable of forming a penta or hexa coordinated silicon species.

More, preferably, the silaphilic catalysts are independently selected from

DMF, DMSO, formamide, N-alkylformamides, N,N-dialkylformamides, acetamide, N-alkylacetamides, N,N-dialkylacetamides, N-Methyl pyrrolidone, p-dimethylaminobenzaldehyde, DMAP, N-methyl imidazole, 1,2-dimethyl imidazole, HMPA, DMPU, NaI, MeONa, MeOLi, Bu4NF, Ph3PO, LiOH, LiStearate and pyridine N-oxide.

The catalysts may be homogenous or heterogeneous but preferably, are homogenous and present in a free form in the reaction medium. Alternatively, the catalysts may be bonded to a polymeric support.

Particularly preferred catalysts are independently selected from

DMF, formamide, N-alkyl formamide, N,N-dialkylformamide, Bu₄NF.

Preferably, the catalysts are present at a level of 0.001-100 mol % (mol/mol silane), more preferably 0.01-40 mol %, most preferably, 0.1-30 mol % in the reaction medium at the start of the reaction. Especially preferred is a range of 20-30 mol % for formamides or 0.1l-1 mol % for Bu₄NF.

Preferably, the reaction is carried out in a suitable solvent.

Suitable solvents which can be used in the process of the invention include non polar inert solvents, aliphatic hydrocarbons, cyclic and non cyclic ethers.

Suitable solvents may be independently selected from pentane, hexane, heptane, toluene, xylene, benzene, mesitylene, ethylbenzene, octane, decane, decahydronaphthalene, diethyl ether, diisopropyl ether, diisobutyl ether or mixtures thereof.

Especially preferred solvents are those which allow reactive distillation ie. which cause no distillation of any of the reactants but which allow preferential distillation of one of the products to drive the equilibrium to the right.

More especially preferred solvents are those which form a low boiling azeotrope with the distilled R⁷OH. Still more especially preferred solvents are those which form a heterogeneous low boiling azeotrope with the distilled R⁷OH.

Most preferably, the solvents are independently selected from pentane, hexane, heptane, toluene and xylene.

Preferably, the temperature of the reaction depends on the boiling point of the azeotrope that has to be distilled, the shape of the reactor and the height of the distillation column.

Typically, the reaction is carried out in the range 0° C.-200° C., more preferably, 60-170° C., most preferably, 110-140° C.

Preferably, the polymerisation inhibitor is present in the range 0.001-10% wt/wt of the total reaction mix, more preferably 0.001-5% wt/wt and most preferably 0.01-2% wt/wt.

Preferably, the molar ratio of silane:acid is between 1:100 and 100:1, more preferably between 10:1 and 1:10, most preferably, between 2:1 and 1:2. Preferably, the molar ratio of silane:acid is approximately 1:1.

Preferably, the solvent is at least 10 wt % of the total reaction mix at the start of the reaction, more preferably, at least 20 wt %, most preferably, at least 30 wt %. The reaction may be carried out at atmospheric pressure although both higher and lower pressures are also possible.

The reaction may also be performed without solvent and accordingly suitable ranges of solvent are 0-99wt % of the total reaction mix, more preferably, 20-50 wt %, most preferably 30-40wt %.

Preferably, R⁴, R⁵ each independently represent an alkyl, an alkoxyl, an aryl, an hydroxyl group or an —O—(SiR⁴R⁵O)ₙ-SiR¹R²R³ group, wherein R¹, R², R³, R⁴ and R⁵ are as defined above and wherein preferably, n=0-100 and more preferably, n=0-10, most preferably n=0 but is also possibly 1, 2, 3, 4 or 5.

More preferably, R⁴ and R⁵ in formula III are each independently selected from the group comprising an alkyl group, an hydroxyl group, an alkoxyl group or an —O—(SiR⁴R⁵O)ₙSiR¹R²R³ group, wherein R¹, R², R³, R⁴ and R⁵ are as defined herein. Most preferably, R¹, R², R³, R⁴ and R⁵ each independently represent an alkyl group.

More preferably, R⁴ and R⁵ in formula I are each independently selected from the group comprising an alkyl group, an —O—(SiR⁴R⁵O)ₙ-SiR¹R²R³ group or OC(O)R⁶ group as previously defined.

According to an embodiment of the present invention, R¹, R², R³, R⁴, R⁵, R⁶ and R⁹ are each independently selected from the group comprising methyl, ethyl, propyl, isopropyl, isobutyl, n-butyl, sec-butyl, t-butyl. Preferably, when they are alkyl groups, R⁴, R⁵, R⁶ and R⁹ are methyl.

Preferably, R⁷ represents a hydrogen atom or an alkyl group.

When ¹, R² and R³ are alkyl groups they are preferably, independently selected from the group consisting of C1 to C8 alkyl groups, preferably C3 and C4, more preferably isopropyl and n-butyl. The said alkyl groups may be branched or linear and, optionally, substituted as aforesaid.

When R⁴ or R⁵ are alkoxyl, they are preferably, C¹-C⁸ oxyl groups which may be branched or linear, more preferably, C¹- C⁴ oxyl groups, most preferably, a methoxyl group.

Preferably, when any one of R¹-R⁵ is selected as —O—SiR¹R²R³ or —O—(SiR⁴R⁵O)ₙ-SiR¹R²R³ the R¹-R⁵ groups attached to the silicon radical in the selected group are not themselves, —O—SiR¹R²R³ or —O—(SiR⁴R⁵O)ₙ-SiR¹R²R³. Preferably, when any one of the R¹-R⁵ groups is selected as —O—SiR¹R²R³ or —O—(SiR⁴R⁵O)ₙ-SiR¹R²R³ and such groups are substituted, the substitution is at the R¹-R⁵ groups and is preferably, by alkyl, alkoxyl, aralkyl, aralkyloxyl, hydroxyl, aryl, aryloxyl, silyl, halogen, amino or amino alkyl, more preferably, alkyl or aryl, most preferably, alkyl.

Preferably, n as used herein each independently represent 0 to 500, more preferably, 1 to 100, most preferably 4 to 50. Especially preferred values for n is selected from 0, 1, 2, 3, 4 or 5.

As used herein, the term “polymer” refers to the product of a polymerisation reaction, and is inclusive of homopolymers, copolymers, terpolymers, etc.

As used herein, the term “copolymer” refers to polymers formed by the polymerisation reaction of at least two different monomers.

As used herein, the term “independently selected” or “independently represent” indicates that the each radical R so described, can be identical or different. For example, each R⁴ in compound of formula (I) may be different for each value of n.

The term “alkyl”, as used herein, relates to saturated hydrocarbon radicals having straight, branched, polycyclic or cyclic moieties or combinations thereof and contains 1 to 20 carbon atoms, preferably 1 to 10 carbon atoms, more preferably I to 8 carbon atoms, still more preferably 1 to 6 carbon atoms, yet more preferably 1 to 4 carbon atoms. Examples of such radicals include may be independently selected from methyl, ethyl, n-propyl, isopropyl n-butyl, isobutyl, set-butyl, tert-butyl, 2-methylbutyl, pentyl, iso-amyl, hexyl, cyclohexyl, 3-methylpentyl, octyl and the like.

The term “alkenyl”, as used herein, relates to hydrocarbon radicals having one or several double bonds, having straight, branched, polycyclic or cyclic moieties or combinations thereof and containing from 2 to 18 carbon atoms, preferably 2 to 10 carbon atoms, more preferably from 2 to 8 carbon atoms, still more preferably 2 to 6 carbon atoms, yet more preferably 2 to 4 carbon atoms. Examples of alkenyl groups include vinyl, allyl, isopropenyl, pentenyl, hexenyl, heptenyl, cyclopropenyl, cyclobutenyl, cyclopentenyl, cyclohexenyl, 1-propenyl, 2-butenyl, 2-methyl-2-butenyl, isoprenyl, farnesyl, geranyl, geranylgeranyl and the like.

The term “alkynyl”, as used herein, relates to hydrocarbon radicals having one or several triple bonds, having straight, branched, polycyclic or cyclic moieties or combinations thereof and having from 2 to 18 carbon atoms, preferably 2 to 10 carbon atoms, more preferably from 2 to 8 carbon atoms, still more preferably from 2 to 6 carbon atoms, yet more preferably 2 to 4 carbon atoms. Examples of alkynyl radicals include ethynyl, propynyl, (propargyl), butynyl, pentynyl, hexynyl and the like.

The term “aryl”, as used herein, relates to an organic radical derived from an aromatic hydrocarbon by removal of one hydrogen, and includes any monocyclic, bicyclic or polycyclic carbon ring of up to 7 members in each ring, wherein at least one ring is aromatic. Said radical may be optionally substituted with one or more substituents independently selected from alkyl, alkoxy, halogen, hydroxyl or amino radicals. Examples of aryl include phenyl, p-tolyl, 4-methoxyphenyl, 4-(tert-butoxy)phenyl, 3-methyl-4-methoxyphenyl, 4-fluorophenyl, 4-chlorophenyl, 3-nitrophenyl, 3-aminophenyl, 3-acetamidophenyl, 4-acetamidophenyl, 2-methyl-3-acetamidophenyl, 2-methyl-3-aminophenyl, 3-methyl-4-aminophenyl, 2-amino-3-methylphenyl, 2,4-dimethyl-3-aminophenyl, 4-hydroxyphenyl, 3-methyl-4-hydroxyphenyl, 1-naphthyl, 2-naphthyl, 3-amino-1-naphthyl, 2-methyl-3-amino-1-naphthyl, 6-amino-2-naphthyl, 4,6-dimethoxy-2-naphthyl, tetrahydronaphthyl, indanyl, biphenyl, phenanthryl, anthryl or acenaphthyl and the like.

The term “aralkyl” as used herein, relates to a group of the formula alkyl-aryl, in which alkyl and aryl have the same meaning as defined above. Examples of aralkyl radicals include benzyl, phenethyl, dibenzylmethyl, methylphenylmethyl, 3- (2-naphthyl)-butyl, and the like.

The term “silyl” as used herein includes -SiR¹R²R³ and -(SiR⁴R⁵O)ₙ-SiR¹R²R³ groups wherein R¹-R⁵ are as defined herein. Preferably when the R¹, R², R³, R⁴ or R⁵ group in formula (I) is substituted by such a silyl group at least one or more of R¹, R², R³, R⁴ and R⁵ in the silyl group -SiR¹R²R³ or -(SiR⁴R⁵O)ₙ-SiR¹R²R³ are alkyl or aryl and at least one or more of R¹, R², R³, R⁴ and R⁵ in the said silyl group which are not alkyl or aryl are —O—SiR¹R²R³ or —O—(SiR⁴R⁵O)ₙ-SiR¹R²R³.

In the silyl -SiR¹R²R³ or -(SiR⁴R⁵O)ₙ-SiR¹R²R³, if R¹ is alkyl or aryl and at least one of R² and R³ is —O—SiR¹R²R³ or —O—(SiR⁴R⁵O)ₙ-SiR¹R²R³ then, preferably, R¹, R², R³, R⁴ and R⁵ in such —O—SiR¹R²R³ or —O—(SiR⁴R⁵O)ₙ-SiR¹R²R³ groups are themselves alkyl or aryl and may be the same or different, more preferably, each independently may be C₁-C₈ alkyl groups.

Examples of the carboxyl radical part of formula (I) may include but are not limited to formyl, acetyl, propionyl, butyryl, pivaloyl, oxaloyl, malonyl, succinyl, glutaryl, adipoyl, benzoyl, phthaloyl, isobutyroyl, sec-butyroyl, octanoyl, isooctanoyl, nonanoyl, isononanoyl, abietyl, dehydroabietyl, dihydroabietyl, naphtenyl, anthracenyl, abietyl dimer (Dymerex®), dihydroabietyl (Foral®) and the like and polymers or copolymers thereof.

In a preferred embodiment, said carboxyl radical part of formula (I) is acetyl, abietyl, dihydroabietyl or abietyl dimer.

Examples of the organosilylated carboxylate compounds of general formula (I) include but are not limited to tri-n-butyl 1-acetoxy-silane, tri-n-propyl-1-acetoxy silane, tri-t-butyl-1-acetoxy-silane, tri-isopropyl-1-acetoxy-silane, tri-isobutyl-1-acetoxy-silane, tri-methyl-1-acetoxy-silane, triethyl-1-acetoxy-silane, tribenzyl-1-acetoxy-silane, triamyl- 1-acetoxy-silane, triphenyl- 1-acetoxy-silane, nonamethyl-1-acetoxy-tetrasiloxane, nonaethyl-1-acetoxy-tetrasiloxane, nona-t-butyl-1-acetoxy-tetrasiloxane, nonabenzyl-1-acetoxy-tetrasiloxane, nona-isopropyl-1-acetoxy-tetrasiloxane, nona-n-propyl-1-acetoxy-tetrasiloxane, nona-isobutyl-1-acetoxy-tetrasiloxane, nona-amyl-1-acetoxy-tetrasiloxane, nona-n-butyl-1-acetoxy-tetrasiloxane, nona-dodecyl-1-acetoxy-tetrasiloxane, nona-hexyl-1-acetoxy-tetrasiloxane, nona-phenyl-1-acetoxy-tetrasiloxane, nona-octyl-1-acetoxy-tetrasiloxane, undecamethyl-1-acetoxy-pentasiloxane, undecaethyl-1-acetoxy-pentasiloxane, undeca-t-butyl-1-acetoxy-pentasiloxane, undecabenzyl-1-acetoxy-pentasiloxane, undeca-isopropyl-1-acetoxy-pentasiloxane, undeca-n-propyl-1-acetoxy-pentasiloxane, undeca-isobutyl-1-acetoxy-pentasiloxane, undeca-amyl-1-acetoxy-pentasiloxane, undeca-n-butyl-1-acetoxy-pentasiloxane, undeca-dodecyl-1-acetoxy-pentasiloxane, undeca-hexyl-1-acetoxy-pentasiloxane, undeca-phenyl-1-acetoxy-pentasiloxane, undeca-octyl-1-acetoxy-pentasiloxane tridecamethyl-1-acetoxy-hexasiloxane, tridecaethyl-1-acetoxy-hexasiloxane, trideca-t-butyl-1-acetoxy-hexasiloxane, tridecabenzyl-1-acetoxy-hexasiloxane, trideca-isopropyl-1-acetoxy-hexasiloxane, trideca-n-propyl-1-acetoxy-hexasiloxane, trideca-isobutyl-1-acetoxy-hexasiloxane, trideca-amyl-1-acetoxy-hexasiloxane, trideca-n-butyl-1-acetoxy-hexasiloxane, trideca-dodecyl-1-acetoxy-hexasiloxane, trideca-hexyl-1-acetoxy-hexasiloxane, trideca-phenyl-1-acetoxy-hexasiloxane, trideca-octyl-1-acetoxy-hexasiloxane, 1,3,3,3-tetramethyl-1-trimethylsilyloxy-1-acetoxy-disiloxane, 1-ethyl,3,3,3-trimethyl-1-trimethylsilyloxy-1-acetoxy-disiloxane, tris-(trimethylsilyloxy)-1-acetoxy-silane and polymers thereof.

Typical examples of the carboxyl part of formula I are acetyl, propionyl, butyryl, malonyl, oxalyl and benzoyl.

The invention will now be described by way of illustration only and with reference to the accompanying examples.

### EXAMPLES

(According to the Invention)

### Example 1

A mixture of 10 g of methoxytributyl silane, 3.77 g of acetic acid, 0.94 g of N,N-dimethylformamide, and 10 ml of heptane is heated. The azeotrope methanol-heptane is then distilled at atmospheric pressure (59.1° C.) to furnish tributylsilyl acetate.

Tributysilyl acetate: ¹³C NMR: 172.2, 26.7, 25.4, 22.9, 14.1, 13.5; ²⁹Si NMR: 22.6; IR (film): 2959, 2927, 1726, 1371, 1257, 1083, 1019, 934, 887 cm⁻¹.

### Example 2

A mixture of 91.8 g of Foral® (hydrogenated Rosin), 17.8 g of methyl triethoxysilane and 7.3 g of N,N-dimethylformamide in 250 ml of toluene are heated. The azeotrope ethanol-toluene is distilled at atmospheric pressure (74.4° C.) to furnish methylsilyl triresinate.

### Example 3

A mixture of 50 g of Silres® SY231, 15 g of acetic acid, 5.4 g of N,N-dimethylformamide, and 100 ml of heptane is heated. The azeotrope methanol-heptane is then distilled at atmospheric pressure (59.1° C.) to furnish the silyl-acetoxy modified resin.

Characteristic signals for acetoxy functions are present on the NMR spectra of the product:
¹³C NMR: 170.1, 23.03; ²⁹Si: −7.05

### Example 4

A mixture of 264 g of Silres® SY231, 178.7 g of hydrogenated Rosin (Foral®), 56.9 g of N-formyl rosinamine and 264 ml of heptane are heated at c.a. 110-137° C. until the azeotrope (methanol-heptane, 59.1° C.) is totally distilled to furnish rosin modified silicone silyl ester. Yield based on the amount of distilled methanol: 65%.

### Example 5

A mixture of 280 g of Silres® SY231, 215 g of Rosin dimer (Dymerex®), 3.95. g of tetrabutylammonium fluoride and 280 ml of heptane are heated at c.a. 100-114° C. until the azeotrope (methanol-heptane, 59.1° C.) is totally distilled to furnish rosin modified silicone silyl ester. Yield based on the amount of distilled methanol: 100%.

### Example 6

A mixture of 282 g of Silres® SY231, 216 g of Rosin dimer (Dymerex®), 0.53 g of lithium hydroxide monohydrate and 282 ml of heptane are heated at c.a. 100-120° C. until the azeotrope (methanol-heptane, 59.1° C.) is totally distilled to furnish rosin modified silicone silyl ester. Yield based on the amount of distilled methanol: 100%.

### Example 7

A mixture of 280 g of Silres® SY231, 215 g of Rosin dimer (Dymerex®), 3.64 g of lithium stearate and 281 ml of heptane are heated at c.a. 100-120° C. until the azeotrope (methanol-heptane, 59.1° C.) is totally distilled to furnish rosin modified silicone silyl ester. Yield based on the amount of distilled methanol: 100%.

### Example 8

A mixture of 287 g of Silres® SY300, 163 g of hydrogenated Rosin (Foral®), 48 g of N-formyl Rosinamine and 287 ml of xylene is heated at c.a. 140° C. The mixture is heated until all the azeotrope (water-xylene, 92° C.) is totally distilled at atmospheric pressure to furnish rosin modified silicone silyl ester. Yield based on the amount of water distilled: 89% Characteristic signals for Rosin modified silicone silyl ester are present on the NMR spectra:
³C NMR: 1709.2, 178.0; ²⁹Si: −6.15

### Example 9

A mixture of 263 g of Silres® SY300, 191 g of Rosin dimer (Dymerex®), 44.7 g of N-formyl Rosinamine and 263 ml of xylene is heated at c.a. 154° C.The mixture is heated until all the azeotrope (water-xylene, 92° C.) is totally distilled at atmospheric pressure to furnish rosin modified silicone silyl ester. Yield based on the amount of water distilled: 92% Example 10

A mixture of 301 g of Silres® SY300, 194 g of Rosin dimer (Dymerex®), 3.58 g of N-tetrabutylammonium fluoride and 301 ml of xylene is heated at c.a. 152° C. The mixture is heated until all the azeotrope (water-xylene, 92° C.) is totally distilled at atmospheric pressure to furnish rosin modified silicone silyl ester. Yield based on the amount of water distilled: 100%

### Example 11

A mixture of 282 g of Silres® SY231, 216 g of Rosin dimer (Dymerex®), 0.86 g of titanium (IV) butoxide and 282 ml of heptane are heated at c.a. 100-120° C. until the azeotrope (methanol-heptane, 59.1° C.) is totally distilled to furnish rosin modified silicone silyl ester. Yield based on the amount of distilled methanol: 100%.

### Example 12

A mixture of 10.9 g of 1,1,1,3,5,5,5-heptamethyl-3-methoxytrisiloxane (CAS RN:7671-19-4), 3.77 g of acetic acid, 0.94 g of N,N-dimethylformamide, and 10 ml of heptane is heated. The azeotrope methanol-heptane is then distilled at atmospheric pressure (59.1° C.) to furnish 1,3,3,3-tetramethyl-1-trimethylsilyloxy-1-acetoxy-disiloxane.
1,3,3,3-tetramethyl-1-trimethylsilyloxy-1-acetoxy-disiloxane ¹³C NMR: 170.4, 22.9, 1.6, −2.6; ²⁹Si NMR: 10.2, −58.4; IR (film):2963, 1735, 1372, 1256, 1091, 1020, 943, 846, 801, 777 cm⁻¹.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s) The invention extends to any novel one, or any novel combination, of the features disclosed in this specification (including any accompanying claims, abstract and drawings), or to any novel one, or any novel combination, of the steps of any method or process so disclosed.

1. A process for production of hydrocarbyl silyl carboxylates of formula (I) 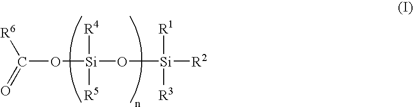
wherein each R⁴ and R⁵ may be hydroxyl or may be independently selected from alkyl, aryl, alkoxyl, aryloxyl, —O—SiR¹R²R³, —O—(SiR⁴R⁵O),-SiR¹R²R³, alkenyl, alkynyl, aralkyl or aralkyloxyl radicals optionally substituted by one or more substituents independently selected from the group comprising alkyl, alkoxyl, aralkyl, aralkyloxyl, hydroxyl aryl, aryloxyl, silyl, —O—SiR¹R²R³, —O—(SiR⁴R⁵O)ₙ-SiR¹R²R³, halogen, amino or amino alkyl radicals or R⁴or R⁵ may be an —O—C(O)R⁶ group,
wherein R¹, R² and R³ each independently represent hydrogen, hydroxyl, alkyl, alkenyl, alkynyl, alkoxyl, —O—SiR¹R²R³, —O—(SiR⁴R⁵O)ₙ-SiR¹R²R³, aryl, aryloxyl, aralkyl or aralkyloxyl radical optionally substituted by one or more substituents independently selected from the group comprising alkyl, alkoxyl, aralkyl, aralkyoxyl, aryl, aryloxyl, silyl, —O—SiR¹R²R³, —O—(SiR⁴R⁵O)ₙ-SiR¹R²R³, halogen, hydroxyl, amino or amino alkyl radicals or R¹, R² and R³ may independently be an —O—C(O)R⁶ group,
wherein R⁶ is a hydrogen atom, or independently represents alkyl, alkenyl, alkynyl, aryl, aralkyl radical optionally substituted by one or more substituents independently selected from the group comprising alkyl, alkenyl, alkynyl, aralkyl, aryl, halogen, hydroxyl, amino or amino alkyl radicals or may be —(R⁸)ₚCOOR⁹ wherein P may be 0 or 1 and when P=1, R⁸ is selected from alkyl, alkenyl, alkynyl aryl, aralkyl radical optionally substituted by one or more substituents independently selected from alkyl, alkenyl, alkynyl, aralkyl, aryl, hydroxyl, halogen, amino or amino alkyl radicals, wherein R⁹ is a hydrogen atom or may be independently selected from alkyl, alkenyl, alkynyl, aryl, aralkyl, -SiR¹R^{R}³, -(SiR⁴R⁵O)ₙ-SiR¹R²R³ radical optionally substituted by one or more substituents independently selected from the group comprising alkyl, alkenyl, alkynyl, aryl, aryloxyl, aralkyl, aralkyloxyl, halogen, hydroxyl, alkoxyl, amino or aminoalkyl radicals and wherein R¹, R², R^{3,}R⁴ and R⁵ are as already defined;
and wherein each n above independently represents a number of dihydrocarbylsiloxane units from 0 to 1000;
by reaction of a carboxylic acid of formula (II) 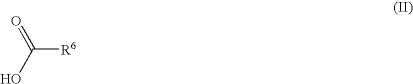
wherein R⁶ is as defined above; with a hydrocarbyl silyl compound of formula (III) 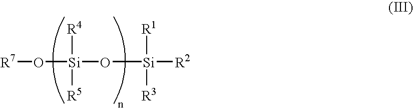
wherein R¹, R², R³, R⁴ and R⁵ are as defined above and R⁷ is an hydrogen atom, an aralkyl, aryl, alkenyl, alkynyl, alkyl group optionally substituted with one or more substituents selected from the equivalent substituents as defined for R¹-R⁵ above; the said reaction being carried out in the presence of a silaphilic catalyst.

2. A process according to claim 1, wherein R⁴, R⁵ each independently represent an alkyl group, an alkoxyl group, an aryl group, an hydroxyl group or an —O—(SiR⁴R⁵O)ₙ-SiR¹R²R³ group, wherein R¹, R², R³, R⁴ and R⁵ are as defined above.

3. A process according to claim 1, R⁴ and R⁵ in formula I are each independently selected from the group comprising an alkyl group, an —O—(SiR⁴R⁵O)ₙ-SiR¹R²R³ group or OC(O)R⁶ group as previously defined.

4. A process according to claim 1, wherein R¹, R², R³, R⁴, R⁵, R⁶ and R⁹ are each independently selected from the group comprising methyl, ethyl, propyl, isopropyl, isobutyl, n-butyl, sec-butyl, t-butyl.

5. A process according to claim 1, wherein R⁴, R⁵, R⁶ and R⁹ are methyl.

6. A process according to claim 1, wherein R¹, R² and R³ are n-butyl.

7. A process according to claim 1, wherein the silaphilic catalysts are selected from fluoride containing mineral or organic salts which comprise, sodium fluoride, potassium fluoride, caesium fluoride or tetrabutyl ammonium fluoride (Bu₄NF); or are selected from N-methyl imidazole (NMI), N,N-dimethylamino pyridine (DMAP), hexamethylphosphoric triamide (HMPA), 4,4 dimethyl imidazole, N methyl-2-pyridone (NMP), pyridine N-oxide, triphenylphosphine oxide, 2,4 dimethyl pyridine, N-methyl 4-pyridone, dimethyl formamide (DMF), 3,5 dimethyl pyridine, N,N-dimethylethylene Urea (DMEU), N,N-dimethylpropylene Urea (DMPU), pyridine, imidazole, trimethylamine, dimethyl sulphoxide (DMSO), N-methyl pyrrolidinone (NMP), formamide, N-alkylformamides, N,N-dialkylformamides, acetamide, N-alkylacetamides, N,N-dialkylacetamides, alkylcyanides, N-methyl pyrrolidone, p-dimethylaminobenzaldehyde, 1,2-dimethyl imidazole, LiOH, LiStearate, NaI, MeONa or MeOLi; wherein the term alkyl includes any linear cyclic, bicyclic, polycyclic, alkyl aliphatic or aromatic group and in the case of N,N-compounds the alkyl may be the same or different.

8. A process according to claim 1, wherein the catalysts are homogenous or heterogeneous.

9. A process according to claim 1, wherein the catalyst is able to coordinate reversibly with the silicon atom.

10. A process according to claim 9, wherein the catalyst is capable of forming a penta or hexa coordinated silicon species.

11. A process according to claim 1, wherein R¹, R², R³, R⁴, R⁵, R⁶ and R⁹ are alkyl radicals independently selected from methyl, ethyl, n-propyl, isopropyl n-butyl, isobutyl, sec-butyl tert-butyl, 2-methylbutyl, pentyl, iso-amyl, hexyl, cyclohexyl, 3-methylpentyl, octyl and the like.

12. A process according to claim 1, wherein the hydrocarbyl silyl esters of formula I are selected from tri-n-butyl 1 -acetoxy-silane, tri-n-propyl-1-acetoxy silane, tri-t-butyl-1-acetoxy-silane, tri-isopropyl-1-acetoxy-silane, tri-isobutyl-1-acetoxy-silane, tri-methyl-1-acetoxy-silane, triethyl-1-acetoxy-silane, tribenzy-1-acetoxy-silane, triamyl-1-acetoxy-silane, triphenyl-1-acetoxy-silane, nonamethyl-1-acetoxy-tetrasiloxane, nonaethyl-1-acetoxy-tetrasiloxane, nona-t-butyl-1-acetoxy-tetrasiloxane, nonabenzyl-1-acetoxy-tetrasiloxane, nona-isopropyl-1-acetoxy-tetrasiloxane, nona-n-propyl-1-acetoxy-tetrasiloxane, nona-isobutyl-1-acetoxy-tetrasiloxane, nona-amyl-1-acetoxy-tetrasiloxane, nona-n-butyl-1-acetoxy-tetrasiloxane, nona-dodecyl-1-acetoxy-tetrasiloxane, nona-hexyl-1-acetoxy-tetrasiloxane, nona-phenyl-1-acetoxy-tetrasiloxane, nona-octyl-1-acetoxy-tetrasiloxane, undecamethyl-1-acetoxy-pentasiloxane, undecaethyl-1-acetoxy pentasiloxane, undeca-t-butyl-1-acetoxy-pentasiloxane, undecabenzyl-1-acetoxy-pentasiloxane, undeca isopropyl-1-acetoxy-pentasiloxane, undeca-n-propyl-1-acetoxy-pentasiloxane, undeca-isobutyl-1-acetoxy-pentasiloxane, undeca-amyl-1-acetoxy-pentasiloxane, undeca-n-butyl-1-acetoxy-pentasiloxane, undeca-dodecyl-1-acetoxy-pentasiloxane, undeca-hexyl-1-acetoxy-pentasiloxane, undeca-phenyl-1-acetoxy-pentasiloxane, undeca-octyl-1-acetoxy-pentasiloxane, tridecamethyl-1-acetoxy-hexasiloxane, tridecaethyl- 1-acetoxy-hexasiloxane, trideca-t-butyl-1-acetoxy- hexasiloxane, tridecabenzy-1-acetoxy-hexasiloxane, trideca-isopropyl-1-acetoxy-hexasiloxane, trideca-n-propyl- 1-acetoxy-hexasiloxane, trideca-isobutyl-1-acetoxy-hexasiloxane, trideca-amyl-1-acetoxy-hexasiloxane, trideca-n-butyl-1-acetoxy-hexasiloxane, trideca-dodecyl-1-acetoxy-hexasiloxane, trideca-hexyl-1-acetoxy-hexasiloxane, trideca-phenyl-1-acetoxy-hexasiloxane, trideca-octyl-1-acetoxy-hexasiloxane, 1,3,3,3-tetramethyl-1-trimethylsilyloxy-1-acetoxy-disiloxane, 1-ethyl-3,3,3-trimethyl-1-trimethylsilyloxy-1-acetoxy-disiloxane, tris-(trimethylsilyloxy)-1-acetoxy-silane and polymers thereof.

13. A process according to claim 1, wherein the catalysts are independently selected from dialkylformamides, acetamide, N-alkylacetamides, N,N-dialkylacetamides, N-Methyl pyrrolidone, p-dimethylaminobenzaldehyde, DMAP, N-methyl imidazole, 1,2-dimethyl imidazole, HMPA, DMPU, Nal, MeONa, MeOLi, Bu4NF, Ph3PO, LiOH, LiStearate and pyridine N-oxide.

14. A process according to claim 1, wherein the catalysts are present at a level of 0.001-100 mol % (mol/mol silane).

15. A process according to claim 1, wherein the reaction includes a polymeric inhibitor.

16. A process according to claim 1, wherein the reaction is carried out in a suitable solvent.

17. A process according to claim 16, wherein suitable solvents include non polar inert solvents, aliphatic hydrocarbons, cyclic and non cyclic ethers.

18. A process according to claim 16, wherein the solvent is independently selected from pentane, hexane, heptane, toluene, xylene, benzene, mesitylene, ethylbenzene, octane, decane, decahydronaphthalene, diethyl ether, diisopropyl ether, diisobutyl ether or mixtures thereof.

19. A process according to claim 16, wherein the solvents are those which allow reactive distillation.

20. A process according to claim 16, wherein the solvent forms a low boiling azeotrope with the distilled R⁷OH.

21. A process according to claim 16, wherein the solvents are independently selected from pentane, hexane, heptane, toluene and xylene.

22. A process according to claim 1, wherein the reaction is carried out in the range 0° C. -200° C.

23. A process according to claim 1, wherein a polymerisation inhibitor is present in the range 0.001-10% wt/wt of the total reaction mix.

24. A process according to claim 1, wherein the molar ratio of silane:acid is between 1:100 and 100:1.

25. A process according to claim 1, wherein the solvent is at least 10 wt % of the total reaction mix at the start of the reaction.

26. A hydrocarbyl silyl ester as defined in formula (I) produced by a process in accordance with claim 1.

27. A process according to claim 1, wherein the amino radical in the definitions of R¹, R², R³, R⁴ and R⁵ is a tertiary amino radical.

28. A process according to claim 1, wherein when R¹, R², R³, R⁴ and R⁵ are alkoxyl, aryloxyl, alkaryloxyl or hydroxyl in formula III, they may independently represent —O—C(O)R⁶ in formula I.

29. A process according to claim 1, wherein when R⁹ represents an alkyl, alkenyl, alkynyl, aryl, aralkyl radical or hydrogen atom in formula (II), it may represent -(SiR⁴R⁵—O)ₙ-SiR¹R²R³ in formula (I).

30. A process according to claim 1, wherein said catalyst may be a metal alkoxide, an organic tin compound, a boron compound or cyclic 1,3, 5-triisopropoxycyclotrialuminoxane and the like.

31. A process according to claim 7, wherein the silaphilic catalyst is N-formyl Rosinamine
